(19) United States
(12) Patent Application Publication
(10) Pub. No.: US 2010/0014116 A1
(43) Pub. Date: Jan. 21, 2010

(54) IMAGE FORMING SYSTEM, IMAGE FORMING APPARATUS, IMAGE PROCESSING APPARATUS, AND IMAGE FORMING METHOD

(75) Inventor: Kenichirou Haruta, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/493,001

(22) Filed: Jun. 26, 2009

(30) Foreign Application Priority Data
Jul. 15, 2008 (JP) 2008-183900

(51) Int. Cl. G06F 15/00; H04N 1/04

(52) U.S. Cl. 358/1.15; 358/474

(57) ABSTRACT

The present invention provides an image forming system, an image forming apparatus, an image processing apparatus, and an image forming method which can reduce an increase in the amount of data even when printing image data with a high resolution. In the present invention, obtained PDL data is divided into vector data and raster data according to attributes of objects, and based on edges of each object of the vector data, an irradiation timing of a light emitting device when printing the object is obtained, and a vector print signal for printing the vector data from the timing is generated. A generated vector print signal is scanned by the light emitting device, and according to a resolution of the raster data, the raster data is scanned by the light emitting device.

### BACKGROUND OF THE INVENTION

1. Field of the Invention

The present invention relates to an image forming system, an image forming apparatus, an image processing apparatus, and an image forming method. More specifically, the present invention relates to a technique for printing by using an image forming apparatus which performs exposure by laser beams, such as an electrophotographic page printer.

2. Description of the Related Art

There is considered an image forming apparatus which can shorten a processing time necessary for drawing processing by economizing the capacity of an image memory by changing the resolution depending on the contents of print data.

There is a conventional technique as follows. In the invention described in Japanese Patent Laid-Open No. H09-141926 (1997), a plurality of laser emitting devices are disposed at different positions on a rotation plane of a polygon mirror, and a single or a plurality of laser emitting devices are driven according to the resolution. Accordingly, without changing the rotation speed of the polygon mirror, the resolution in the vertical scanning direction (sub scanning direction) (sub scanning direction) (sub scanning direction) (sub scanning direction) is changed. The resolution in the main scanning direction can be easily changed by changing the driving period of the laser emitting device, and therefore, according to the invention described in Japanese Patent Laid-Open No. H09-141926 (1997), the resolution of a print image in a laser printer can be easily changed.

However, in the method described in Japanese Patent Laid-Open No. H09-141926 (1997), image data with a high resolution must be held in the image memory, and when many regions of drawing have a high resolution or higher-definition printing is performed, the capacity of the image memory increases, which is a problem.

### SUMMARY OF THE INVENTION

The present invention was made in view of this problem, and an object thereof is to provide an image forming system, an image forming apparatus, an image processing apparatus, and an image forming method which can reduce an increase in the amount of data even when printing image data with a high resolution.

The present invention provides an image forming system which comprises an image processing apparatus and an image forming apparatus connected to the image processing apparatus, and prints, by the image forming apparatus, print data obtained by the image processing apparatus, wherein the image processing apparatus comprises: a dividing component configured to divide the obtained print data into vector data and raster data according to attributes of objects; and a component configured to transmit the divided raster data and vector data to the image forming apparatus, and the image forming apparatus comprises: a component configured to receive raster data and vector data transmitted from the image processing apparatus; a printing timing generating component configured to acquire an irradiation timing of a light emitting device when printing each object based on edges of the object of the received vector data, and generates a vector print signal for printing the vector data from the timing; a first scanning component configured to scan the vector print signal generated in the printing timing generating component by the light emitting device; and a second scanning component configured to scan the received raster data by the light emitting device according to a resolution of the raster data.

Further features of the present invention will become apparent from the following description of exemplary embodiments (with reference to the attached drawings).

### BRIEF DESCRIPTION OF THE DRAWINGS

FIG. 1 is a schematic view of an image processing system configuration in a first embodiment of the present invention;

FIG. 2 is a block diagram showing a functional configuration of an image processing apparatus 21 in the first embodiment of the present invention;

FIG. 3 is a sectional view showing a general configuration of an image forming apparatus 2 in the first embodiment of the present invention;

FIG. 4 is a block diagram showing a functional configuration of an exposure controller 301 in the first embodiment of the present invention;

FIG. 5 is a view for describing in detail the interior of scanners 407, 409, 411, and 413 in the first embodiment of the present invention;

FIG. 6 is a view for describing in detail the interior of scanners 408, 410, 412, and 414 in the first embodiment of the present invention;

FIG. 7 is a view showing a mechanical configuration of the scanners 407 to 414 in the first embodiment of the present invention;

FIG. 8 is a flowchart showing processing steps of the image forming apparatus 2 in the first embodiment of the present invention;

FIG. 9 is a view showing scanning of the scanners 407, 409, 411, and 413 in the first embodiment of the present invention;

FIG. 10 is a view showing scanning of the scanners 408, 410, 412, and 414 in the first embodiment of the present invention;

FIG. 11 is a flowchart showing processing steps of developing processing in the first embodiment of the present invention;

FIG. 12 is a time chart showing operations of a light amount control signal generator 406 in the first embodiment of the present invention;

FIG. 13 is an explanatory view of a method for creating an edge list in the first embodiment of the present invention;

FIG. 14 is a view showing an example of the edge list in the first embodiment of the present invention;

FIG. 15 is a view showing an example of a scanning time list in the first embodiment of the present invention;

FIG. 16 is a block diagram showing a functional configuration of scanners 407, 409, 411 and 413 in a second embodiment of the present invention;

FIG. 17 is a block diagram showing a functional configuration of scanners 408, 410, 412, and 414 in the second embodiment of the present invention;

FIG. 18 is a view schematically showing equivalent resolution developed signals of one page in a third embodiment of the present invention;

FIG. 19 is a view schematically showing raster print signals of one page in the third embodiment of the present invention;

FIG. 20 is a view schematically showing raster light amount control signals of one page for controlling the light amounts of laser devices which scan raster print signals in the third embodiment of the present invention;

FIG. 21 is a view for describing in detail the interior of scanners 408, 410, 412, and 414 in the third embodiment of the present invention; and

FIG. 22 is a flowchart showing processing steps of an image forming apparatus 2 in the third embodiment of the present invention.

### DESCRIPTION OF THE EMBODIMENTS

Hereinafter, embodiments of the present invention will be described in detail with reference to the drawings. In the drawings described below, components having the same functions are attached with the same reference numerals, and overlapping description thereof will be omitted.

### First Embodiment

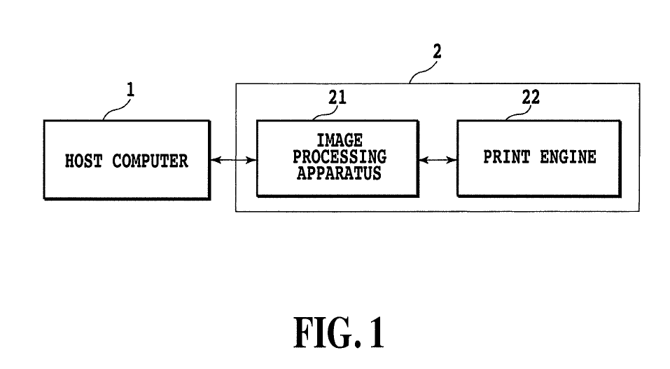

FIG. 1 is a schematic view of a system configuration in the present embodiment.

The image processing system shown in FIG. 1 includes a host computer 1, an image processing apparatus 21, and a print engine 22.

The host computer 1 is a computer such as a general PC (personal computer) or a WS (work station). Images and documents created on the computer 1 are input as PDL data into the image processing apparatus 21. PDL is a page description language, and is a programming language for designating a layout of characters and figures on a “page” as an object to be printed or displayed.

The image processing apparatus 21 is connected to the host computer 1 and the print engine 22, receives (obtains) image data (PDL data) to be printed from the host computer 1, and coverts the image data into print data for printing by the print engine 22 and outputs it to the print engine 22.

The print engine 22 performs printing processing based on the print data output from the image processing apparatus 21.

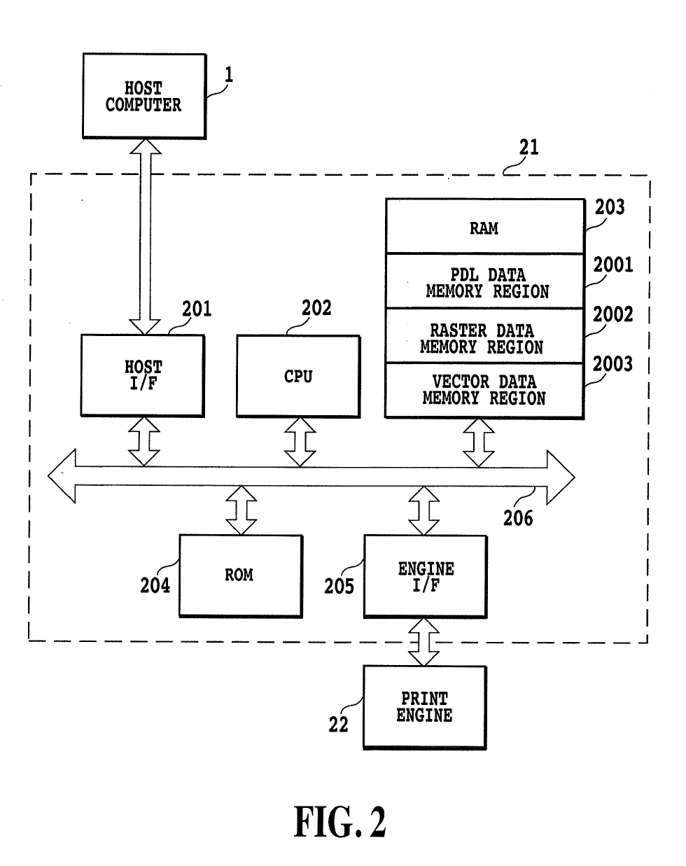

Next, details of the image processing apparatus 21 will be described. The image processing apparatus 21 includes, as shown in FIG. 2, a host I/F 201, a CPU 202, a RAM 203, a ROM 204, and an engine I/F 205.

The host I/F 201 functions as an interface for receiving image data transferred from the host computer 1. For example, the host I/F 201 consists of Ethernet (registered trademark), serial interface, or parallel interface.

The CPU 202 controls the entirety of the image processing apparatus 21 by using programs and data stored in the RAM 203 and ROM 204, and executes the processings of the image processing apparatus 21 described later.

The RAM 203 has a work area to be used when the CPU 202 executes various processings. The RAM 203 further has a PDL data memory region 2001, a raster data memory region 2002 as a first storing component, and a vector data memory region 2003 as a second storing component. The raster data memory region 2001 holds raster data, and the vector data memory region 2003 holds vector data. These raster data memory region 2001 and the vector data memory region 2003 are necessary for transferring image data to the print engine 22 in synchronization with printing timings of the respective colors by time-delaying the image data on a color basis.

The ROM 204 stores programs and data for making the CPU 202 control the entirety of the image processing apparatus 21 and making the CPU 202 execute various processings described later of the image processing apparatus 21, and setting data of the image processing apparatus 21.

The engine I/F 205 controls a processing for transferring the print data which has already been subjected to image processing by the image processing apparatus 21 to the print engine 22.

The reference numeral 206 denotes an internal bus of the image processing apparatus 2 which connects the respective components described above.

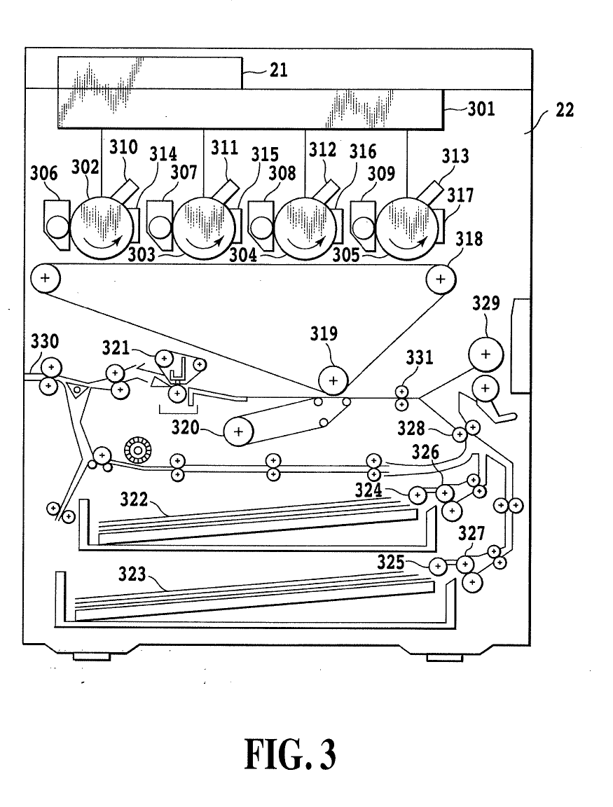

Next, details of the print engine 22 will be described. The print engine 22 is configured as shown in FIG. 3. Photosensitive drums 302, 303, 304, and 305 as image carriers are axially supported at their centers, and are driven to rotate in the arrow direction. Opposite to the outer peripheral surfaces of the photosensitive drums 302 to 305, primary chargers 310, 311, 312, and 313, an exposure controller 301, and developing devices 306, 307, 308, and 309 are disposed in the rotation directions of the photosensitive drums 302 to 305. By the primary chargers 310 to 313, the surfaces of the photosensitive drums 302 to 305 are uniformly charged with uniform charge amounts. Then, the exposure controller 301, the photosensitive drums 302 to 305 are exposed to light beams such as laser beams modulated according to recording image signals, and accordingly electrostatic latent images are formed on the photosensitive drums 302 to 305.

Further, the electrostatic latent images are developed by the developing devices 306 to 309 accommodating developers (toners) of tour colors of yellow, cyan, magenta, and black respectively. On the downstream side of the image transfer regions in which the developed visible images are transferred onto an intermediate transfer body, the drum surfaces are cleaned by brushing off the toners which were not transferred onto a recording sheet but remained on the photosensitive drums 302 to 305 by cleaning devices 314, 315, 316, and 317. Through the above-described process, images of the respective toners are successively formed.

On the other hand, a recording sheet which is picked up by a pickup roller 324 or 325 from an upper cassette 322 or lower cassette 323 is conveyed by sheet feed rollers 326 or 327 is conveyed to registration rollers 331 by conveyance rollers 328. Then, at the timing of the end of transfer onto the intermediate transfer body 319, the recording sheet is conveyed between the intermediate transfer body 319 and the transfer belt 320. Thereafter, the recording sheet is conveyed by a transfer belt 320 and pressure-bonded to the intermediate transfer body 319, and toner images on the intermediate transfer body 319 are transferred onto the recording sheet. The toner images transferred onto the recording sheet are fixed onto the recording sheet by being heated and pressurized by a fixing roller and a pressurizing roller 321.

The recording sheet onto which the image is fixed is discharged to a face-up discharge opening 330.

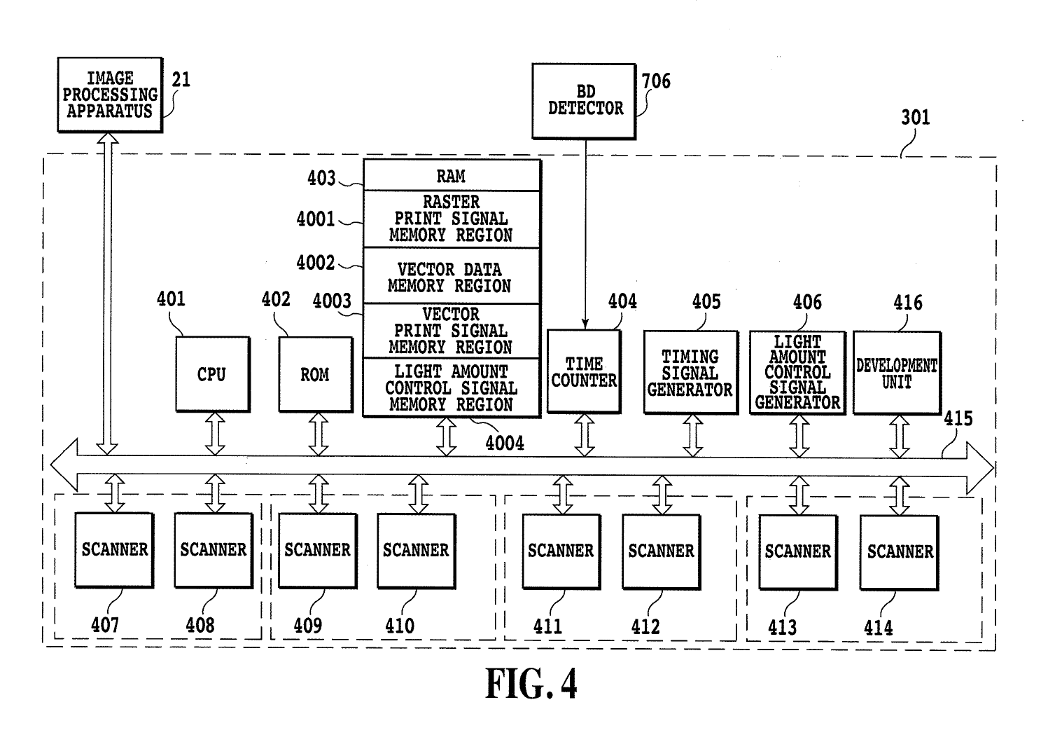

Next, details of the exposure controller 301 will be described. The exposure controller 301 includes, as shown in FIG. 4, a CPU 401, a ROM 402, a RAM 403, a time counter 404, a timing signal generator 405, a light amount control signal generator 406, and scanners 407, 408, 409, 410, 411, 412, 413, and 414.

The CPU 401 controls the entirety of the exposure controller 301 by using programs and data stored in the RAM 403 and ROM 402, and executes processings described later of the exposure controller 301.

The ROM 402 stores programs and data for making the CPU 401 control the entirety of the exposure controller 301 and making the CPU 401 execute various processings described later of the exposure controller 301, and setting data of the exposure controller 301.

The RAM 403 has a raster print signal memory region 4001, a vector data memory region 4002, a vector print signal memory region 4003, and a light amount control signal memory region 4004 in addition to a work area to be used when the CPU 401 executes various processings.

A time counter 404 is reset by a signal from a BD detector 706 and counts the time. In other words, the time counter 404 sums the count every predetermined time. When scanning shifts from a current scanning line to the next scanning line, as described later, a laser beam is detected by the BD detector 706, and this BD detector 706 transmits a reset signal to the time counter 404. When the time counter 404 receives the reset signal, it resets the summed count. Accordingly, the time counter 404 can provide the times from the start of scanning to the end of scanning on a certain scanning line. As described later, by using the times provided from the time counter 404 and the ON/OFF timings (scanning time list) of laser irradiation, a vector print signal can be generated.

The timing signal generator 405 generates a scanning signal (vector print signal) of a character portion from the scanning time list such as the scanning time list 1501 and a value counted by the time counter.

The light amount control signal generator 406 generates a light amount control signal from a raster print signal and the scanning signal of the character portion.

The scanner 407 as a first scanning component controls ON/OFF of the laser beam to be irradiated onto the photosensitive material 302 by supplying a vector print signal to the laser device inside the scanner 407, and forms an electrostatic latent image on the photosensitive material 302. Further, the scanner 407 adjusts the light amount of the laser beam based on the light amount control signal.

The scanner 408 as a second scanning component controls ON/OFF of the laser beam to be irradiated onto the photosensitive material 302 by supplying a raster print signal to the laser device inside the scanner 408, and forms an electrostatic latent image on the photosensitive material 302. This scanner 408 scans the raster print signal according to a resolution of raster data obtained by division as described later.

The scanners 409, 411, and 413 have the same configuration as that of the scanner 407.

The scanners 410, 412, and 414 have the same configuration as that of the scanner 408.

The reference numeral 415 denotes an internal bus of the exposure controller 301 which connects the respective components described above.

An development unit 416 creates a scanning time list by listing scanning timings based on vector data output from the image processing apparatus 21.

Next, processing to be performed by the image forming apparatus 2 when PDL data is transferred from the host computer 1 to the image forming apparatus 2, will be described.

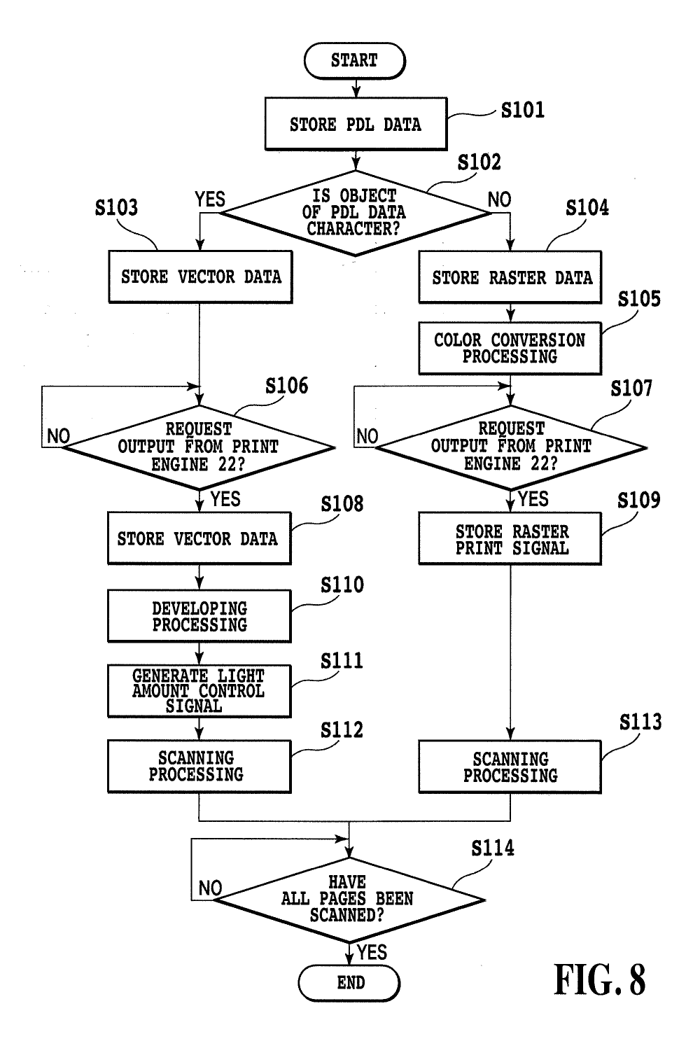

FIG. 8 is a flowchart showing processing to be performed by the image forming apparatus 2 when the image forming apparatus 2 receives PDL data from the host computer 1.

Via the host I/F 201, when the CPU 202 detects receiving of the PDL data from the host computer 1, processing according to the flowchart of the same figure is started. First, the CPU 202 temporarily stores the received PDL data in the PDL data memory region 2001 of the RAM 203 (Step S101).

Generally, when an image to be printed is created by the host computer, by executing an application program in the computer, image data (print data such as PDL data) is realized by using a description language in the command format of PDL or GDI. Thereafter, by analyzing the respective commands, intermediate codes showing how to develop the commands in the band memory (RAM 203 in the present embodiment) are generated. As the intermediate codes, for each pixel, a code unique to a drawing object is generated in addition to RGB tone values. In other words, in the case of a character, “PUTCHARCACHE, (memory number),” etc., for reading out a character itself stored in the memory is generated. In the case of graphics, “RECTANGLE” or “CIRCLE” for expressing a rectangle or circle, and in the case of a bitmap image, “IMAGE” or the like is generated. Therefore, among intermediate codes input in the CPU 202, when “PUTCHARCACHE, (memory number)” is described, it is determined as being a character, and when it is not described, it is determined as not being a character. Of course, a code of vector (other than image) may be determined from an intermediate code unique to graphics other than characters.

The CPU 202 analyzes commands of PDL data and separates these into characters and others (Step S102). Command information of a character is stored in the vector data memory region 2003 (Step S103). In the case of a graphic or a bitmap image, the data is developed to raster data and stored in the raster data memory region 2002 (Step S104). In other words, the CPU 202 divides PDL data as obtained print data into two types of data according to attributes of the PDL data and develops these to acquire vector data and raster data. Raster data and vector data thus obtained are image data in the same page.

In the present embodiment, raster data is developed at 600 dpi by way of example. At this time, commands of characters which overlap an image and are not printed in actuality are deleted.

Next, the CPU 202 applies color conversion processing to the raster data held in the raster data memory region 2002 at Step S104 (Step S105). Data thus subjected to color conversion processing becomes raster print signals.

The color conversion processing is processing for converting image data expressed in three colors of RGB generated on the host computer 1 side into CMYK data capable of being processed by the print engine 22, and is performed by using tables and functions, etc., stored in the ROM 204 and RAM 203.

When the CPU 202 receives a request from the print engine 22 via the engine I/F 205 (Step S106), it transfers the vector data stored in the vector data memory region 2003 to the print engine 22.

When the CPU 202 receives requests on a color basis from the print engine 22 via the engine I/F 205 (Step S107), the CPU 202 transfers raster print signals stored in the raster data memory region 2002 to the print engine 22.

The requests from the print engine 22 are issued at timings of outputting image data for image formation on the photosensitive materials in synchronization with the timings of passage of the sheet through the plurality of photosensitive materials arranged in parallel.

Image data (vector data and raster data) transferred from the image processing apparatus 21 are input into the exposure controller 301 of the print engine 22.

The CPU 401 temporarily stores the print data (vector data and raster data) received from the image processing apparatus 21 in the RAM 403. In other words, in the received print data, the CPU 401 stores the vector data in the vector data memory region 4002 (Step S108) and stores the raster print signals (raster data) in the raster print signal memory region 4001 (Step S109).

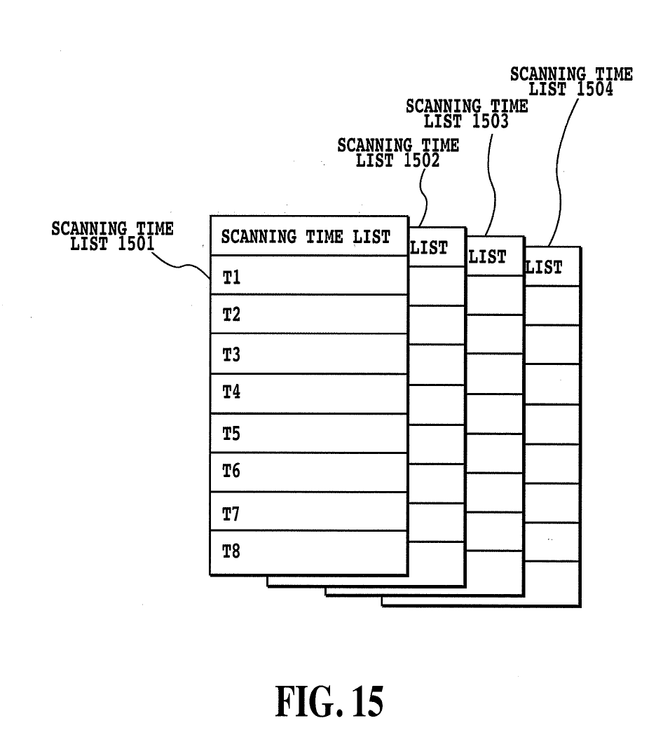

The development unit 416 creates scanning time lists 1501, 1502, 1503, and 1504 as shown in FIG. 15 described later for the respective CMYK colors based on the vector data stored at Step S108. Details of Step S106 will be described in detail later. The scanning time list is a list of scanning timings based on the relationship between edges of each object and the main scanning line. In other words, the scanning time list is a list of ON and OFF timings of irradiation of a laser beam for forming the object on a certain main scanning line. Therefore, by using the scanning time list, as described later, when the ON/OFF timing matches each time obtained from the time counter 404, a signal (vector print signal) for turning ON/OFF the irradiation of the laser beam can be generated.

The CPU 401 inputs scanning time lists 1501, 1502, 1503, and 1504 into the timing signal generator 405. The timing signal generator 405 receives a value output from the time counter 404. The received value and the scanning time list 1501, 1502, 1503, or 1504 are compared, and when they match each other, ON/OFF of the vector print signal is switched to create a vector print signal (Step S110). The created vector print signal is stored in the vector print signal memory region 4003.

The vector print signal is a signal (timing information) showing at which timing the irradiation of the laser beam is going to be turned ON or OFF on each main scanning line. In other words, on a certain main scanning line, a region in which the irradiation of the laser beam is ON is a region in which an object has been formed, so that a vector print signal is for controlling the driving (ON/OFF) of the laser beam based on edges (on an edge basis) of the object in the main scanning direction. Therefore, the CPU 401 can control turning (irradiation) ON and OFF of the laser beam on an edge basis of the object by using the vector print signal.

Thus, in the present embodiment, the vector print signal for printing an image with an attribute which is determined to be processed with vector data consists of laser beam irradiation timing information, so that even when the vector data to be developed has a high-resolution, the information amount increase can be reduced.

The raster print signals are for driving the scanners 408, 410, 412, and 414 on a pixel basis. On the other hand, the vector print signals are for driving the scanners 407, 409, 411, and 413 on a clock basis by using the scanning time lists and the count value from the time counter 404. Therefore, the light source drivers of the scanners 407, 409, 411, and 413 can be driven on an edge basis, and smoother printing can be realized.

The CPU 401 inputs the raster print signal held in the raster print signals memory region 4001 at Step S108 and the vector print signals generated at Step S110 into the light amount control signal generator 406. The light amount control signal generator 406 creates a light amount control signal from the input data (Step S111) and stores it in the light amount control signal memory region 4004. Details of the method for creating the light amount control signal will be described later.

The generated light amount control signal is input into each scanner in synchronization with the target vector print signal and raster print signal, and scanning processing is applied to each photosensitive material (Step S112, Step S113).

At Step S114, it is confirmed that all pages have been scanned, and then the processing by the image forming apparatus 2 is ended.

Through the above-described data flow, by outputting printing timing information when developing image data of a character portion which needs a high resolution, the data amount can be reduced. As a result, the capacity of the image memory can be reduced even when the character portion is printed with high definition.

In other words, in the present embodiment, the image processing apparatus 21 divides obtained print data into vector data and raster data according to attributes of objects included in the print data. Then, the image processing apparatus 21 applies predetermined processing (color processing), etc., to the raster data and transmits the raster data as it to the print engine 22. Further, the image processing apparatus 21 transmits vector data to the print engine 22 on a color basis.

Therefore, for example, by making a setting so that the attributes of characters, graphs, and figures, etc., are developed to vector data, even when the characters, graphs, and figures are output with a high-resolution, the characters, graphs, and figures are transferred as vector data to the print engine 22. Therefore, the print data can be transmitted to the print engine 22 while the data amount is reduced, and the costs of processing and data transmission can be reduced.

The print engine 22 obtains timing information of driving of the laser beams obtained on an edge basis of objects on each main scanning line from the vector data transmitted from the image processing apparatus 21. Then, the print engine 22 develops the obtained timing information on a clock basis (by associating the timing information with time) to generate a vector print signal, and based on the vector print signal, performs scanning of the vector data with a laser beam. Therefore, even if the vector data has a high resolution, the capacity of the memory used in the print engine 22 can be reduced.

Further, in the present embodiment, the print engine 22 controls ON/OFF of the irradiation of the laser beam not on a pixel basis but on an edge basis. Therefore, for example, when a setting is made so that the attributes of characters, graphs, and figures etc., are developed to vector data, the characters, graphs, and figures can be printed with a higher definition than conventionally.

Subsequently, exposure processing in each scanner will be described.

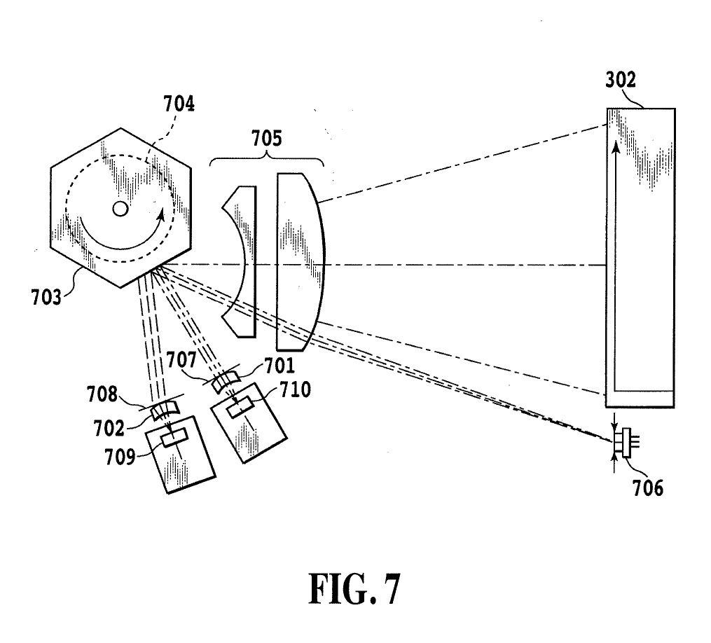

FIG. 7 is a view showing a mechanical configuration of the scanners 407 and 408.

The scanners 409 and 410, the scanners 411 and 412, and the scanners 413 and 414 also have the same configuration.

In FIG. 7, the laser device 709 is a laser device for vector print signal, and the laser device 710 is a laser device for raster print signal. Laser beams emitted from the laser devices 709 and 710 are shaped into substantially parallel light by collimator lenses 701 and 702 and diaphragms 707 and 708, and made incident on a rotating polygon mirror 703 with a predetermined beam diameter.

The polygon mirror 703 is rotated by a polygon motor 704 in the arrow direction shown in FIG. 7 at an equiangular velocity, and the reflection (advancing) direction of the laser beams made incident on the polygon mirror 703 is deflected at the equiangular velocity along with the rotation of the polygon mirror 703. This polygon mirror 703 rotates at a number of rotations based on the resolution of scanning by the scanner 407.

As is noted from FIG. 7, in the present embodiment, the scanners 407 and 408 share the polygon mirror.

The laser beams whose advancing directions are deflected are made incident on the photosensitive material 302 via an f-θ lens 705 and exposure-scans the photosensitive material 302. At this time, the f-θ lens 705 corrects a change in main scanning speed caused by a difference in optical path length to the photosensitive material 302 of the laser beams whose advancing directions are deflected by the polygon mirror 703 so as to obtain a constant main scanning speed.

The BD detector 706 is a beam detect sensor which detects the laser beams from the polygon mirror, and after a predetermined time since detection of the laser beams by the BD detector 706, exposure scanning with the laser beams based on the image data is started. When the BD detector 706 detects the laser beams, it transmits a signal indicating this detection (reset signal) to the time counter 404.

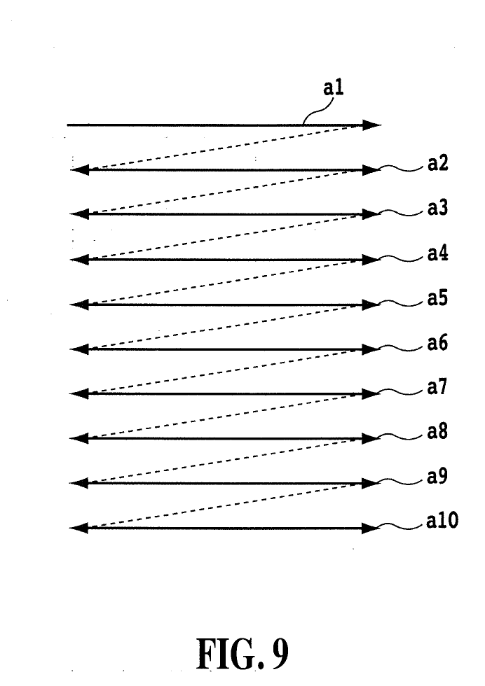

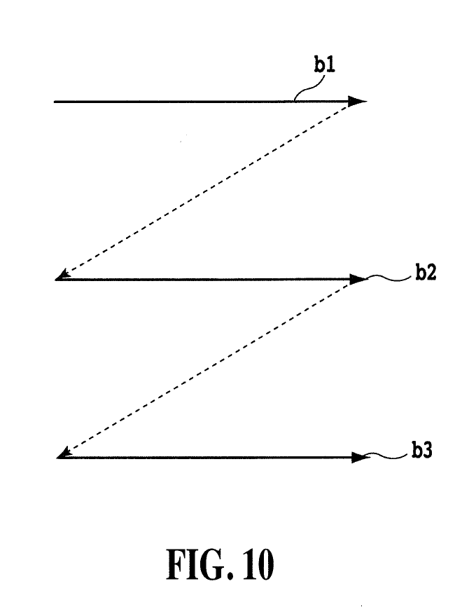

FIG. 9 is a view showing scanning of a laser device for high resolution, and FIG. 10 is a view showing scanning of a laser device for low resolution.

The line a1 scanned by the laser device for high resolution and the line b1 scanned by the laser device for lower resolution are at the same position on a page. The same applies to a5 and b2. In other words, during scanning of a2, a3, and a4 by the laser device for high resolution, the laser device for low resolution does not perform scanning.

In the present embodiment, laser beam irradiation for a vector print signal and laser beam irradiation for a raster print signal are performed by the common polygon mirror, however, when the resolution of the vector print signal is higher than that of the raster print signal, the CPU 401 performs the following control. In other words, the CPU 401 does not turn ON the laser for the scanning lines (for example, a2 to a5) for the vector print signal which are not included in the scanning lines for the raster print signal, and performs laser irradiation control of the scanner for raster print signal for each scanning line.

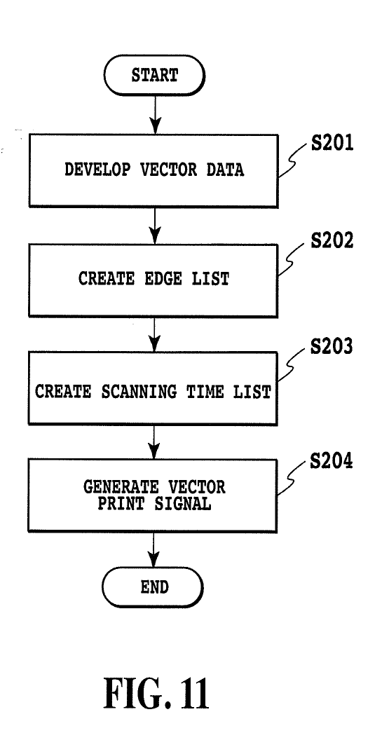

The detailed flow of developing processing (printing timing generation processing) of the above-described Step S110 will be described with reference to the flowchart shown in FIG. 11.

First, at Step S201, the development unit 416 develops objects present on the main scanning of vector data transmitted to the image processing apparatus 22 and stored at Step S108.

Next, at Step S202, the development unit 416 calculates the coordinates of start positions and end positions of drawing of an object present on the main scanning developed at Step S201 to create an edge list of the coordinates of the start positions and the end positions of drawing of the object. In other words, the development unit 416 detects edges of an object by calculating the coordinates of a start position and an end position of the object on each main scanning line.

Then, at Step S203, the development unit 416 calculates main scanning printing timings (times) based on the edge list created at Step S202. The results of calculation are listed as a scanning time list. In other words, based on the edges detected at Step S202, the development unit 416 calculates timings so as to perform laser irradiation onto a region between an edge and an edge, that is, an object portion. Therefore, the development unit 416 calculates ON/OFF timings of the laser beam irradiation on an edge basis.

At Step S204, the timing signal generator 405 generates vector print signals based on the scanning time lists obtained at Step S203 and values from the time counter 404.

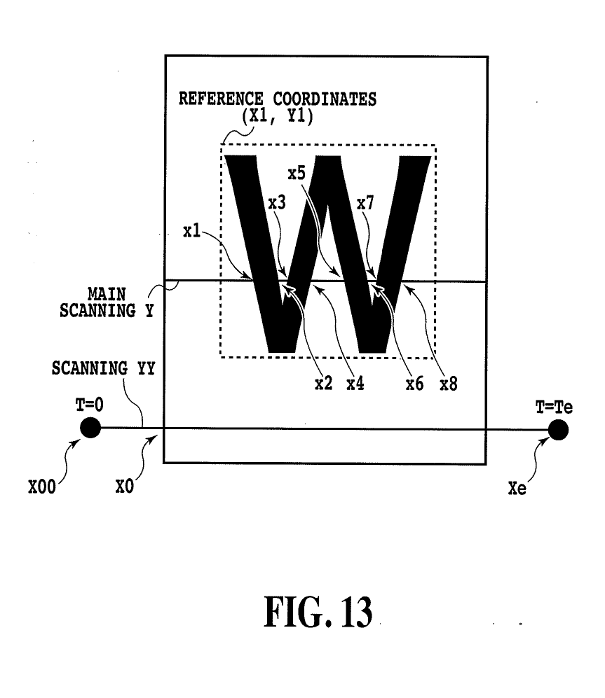

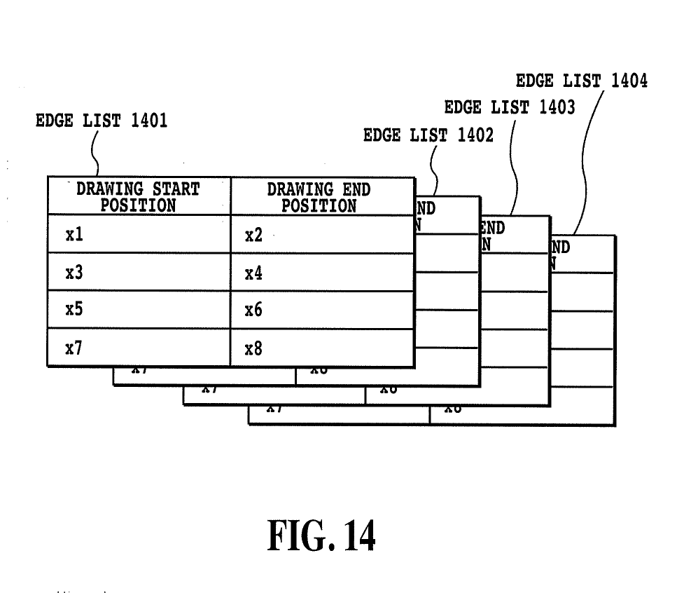

Details will be described with reference to FIG. 13, FIG. 14, and FIG. 15 according to the steps of generating a cyan vector print signal on the main scanning Y.

It is assumed that the vector data is described as follows.

“Object 1 is on reference coordinates (X1, Y1), character ID 01, font size 10, and the color is cyan.”

The reference coordinates indicate an object drawing start position. The character ID shows character information, and object ID 01 corresponds to “W.” In actuality, not the above description but commands showing the same contents are included.

The development unit 416 develops the object 1 present on the main scanning Y (Step S201).

Next, the development unit 416 obtains coordinates of start positions and end positions of drawing of an object present on the main scanning as shown in FIG. 13. In FIG. 13, the drawing start positions of the object are x1, x3, x5, and x7, and the drawing end positions are x2, x4, x6, and x8. The edge list 1401 of FIG. 14 is a list of the results of start positions and end positions of drawing (Step S202).

The development unit 416 substitutes the edge list 1401 into the following formula to create a scanning time list 1501 showing printing timings in the scanning of FIG. 15.

t=Te×((x+X0)/Xe)

Scanning with the laser is like the scanning YY of FIG. 13.

The scanning start position X00 and the scanning start time are used as references, and the scanning end position Xe is a distance from the scanning start position X00, and the scanning end time Te is a time since the scanning start time. The start time is a time at which the BD detector 706 detects a laser beam and the time counter 404 receives a signal.

The development unit 416 calculates the scanning times t1, t2, t3, t4, t5, t6, t7, and t8 by substituting the respective values x1, x2, x3, x4, x5, x6, x7, and x8 of the edge list 1401 for x of the above-described formula.

A scanning time list 1501 which is a list of the calculation results is shown in FIG. 15.

Next, in the timing signal generator 405, when a value of the scanning time list 1501 and a value output from the time counter 404 matches, a vector print signal is generated by switching ON/OFF of the signal.

The vector print signals of magenta, yellow, and black are also generated by the same steps according to the above-described flow.

Conventionally, when rendering is performed, a resolution is set, and image data is created on a pixel basis. Therefore, for image data in which images and characters are mixed, data on all pixels must be held. However, as in the present embodiment, for the character portion, by holding only printing timings, the data amount is reduced, and the memory can be reduced.

To print the character portion with higher definition, the resolution must be increased. If the resolution is increased, the data amount increases. If the data amount increases, a large-capacity memory is necessary or the bandwidth of the bus must be broadened, and this greatly depends on the hardware configuration of the image processing system. In the configuration of the image forming apparatus 2 described above, the resolution of drawing can be set without depending on the hardware configuration of the image processing system.

A detailed flow of the light amount control signal generation processing of Step S111 described above will be described.

The CPU 401 inputs a vector print signal and a raster print signal obtained as described above into the light amount control signal generator 406. Then, the light amount control signal generator 406 performs light amount control signal generation processing and outputs a light amount control signal. The output light amount control signal is stored in the light amount control signal memory region 4004.

In the present embodiment, the print data is divided into raster data and vector data according to attributes of objects included in the print data, and performs laser beam irradiation separately based on the raster data and a vector print signal generated from the vector data. Therefore, in a region having an overlap of raster data and vector data, laser beam irradiation for the raster data (raster print signal) and laser beam irradiation for the vector print signal overlap each other, and this can make dense the latent image to be formed. Therefore, for higher-quality printing, in the overlapped region, preferably, the light amount of the laser beam is adjusted. Therefore, in the present embodiment, light amount control signal generation processing is performed, and based on a light amount control signal, laser beam irradiation for the vector print signal is performed.

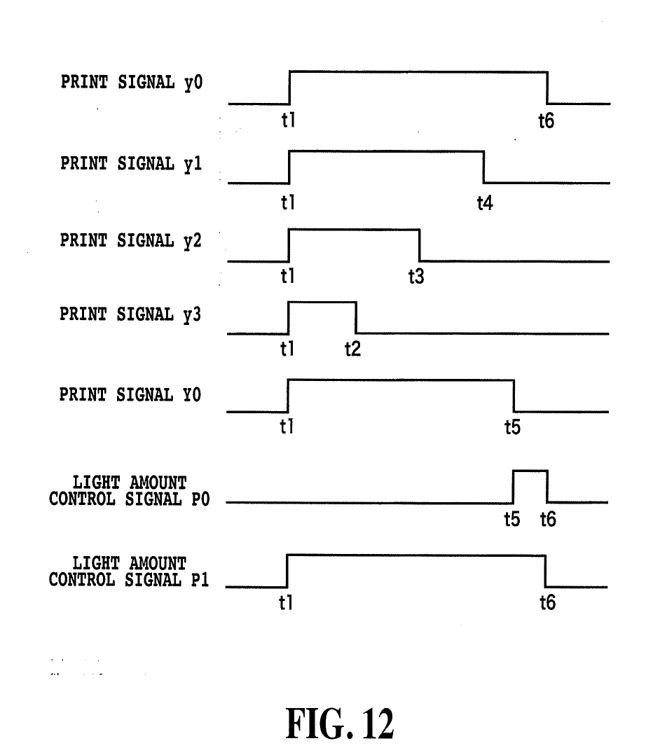

The light amount control signal generation processing will be described with reference to the explanatory view of FIG. 12.

It is assumed that scans y0, y1, y2, and y3 of the vector print signals are to be compared with a scan Y0 of the raster print signal.

In the present embodiment, the light amount control signal consists of two signals. The light amount control signals P0 and P1 control the light amount of the laser device for vector print signal printing as follows.

(Relationship Between Light Amount Control Signal and Light Amount)

The light amount is adjusted to “0” when (P0, P1)=(0, 0)

The light amount is adjusted to “weak” when (P0, P1)=(0, 1)

The light amount is adjusted to “strong” when (P0, P1)=(1, 1)

First, the scan y0 of the vector print signal and the scan Y0 of the raster print signal are input into the light amount control signal generator 406 and subjected to the light amount control signal generation processing. In other words, the light amount control signal generator 406 outputs the input vector print signal of the scan y0 as a light amount control signal P1. Further, the light amount control signal generator 406 generates a light amount control signal P0 based on the input vector print signal of the scan y0 and the input raster print signal of the scan Y0 so that a time zone in which only the vector print signal becomes “1,” becomes “1.”

In detail, in FIG. 12, from t1 to t5, the vector print signal of the scan y0 and the raster print signal of the scan Y0 overlap, so that the light amount of the laser beam irradiation for the vector print signal in this time zone must be adjusted to “weak.” In other words, the combination of the light amount control signals P0 and P1 must be realized so as to realize this “weak.” Therefore, in the time zone from t1 to t5, as is noted from FIG. 12, the light amount control signal P1 is “1,” so that from the description given above (Relationship between light amount control signal and light amount), the light amount control signal P0 becomes “0.” Further, from t5 to t6, only the vector print signal of the scan y0 is present, so that the light amount of the laser beam irradiation for the vector print signal in this time zone must be adjusted to “strong.” In other words, in the time zone from t5 to t6, to realize this “strong,” the light amount control signal P0 becomes “1” from the description given above (Relationship between light amount control signal and light amount). During the time other than the above-described time zones, the vector print signal of scan y0 is not present, so that the light amount of the laser beam irradiation for the vector print signal is adjusted to “0.” Therefore, in these time zones, the light amount control signal P0 becomes “0.”

The same light amount control signal generation processing is performed for each scan to generate light amount control signals P0 and P1 of each scan.

Thus, for the region having an overlap of an object to be formed by a vector print signal and an object to be formed by a raster print signal, the light amount of the laser beam irradiation for the vector print signal is reduced, so that this overlapped region can be restrained from becoming dense.

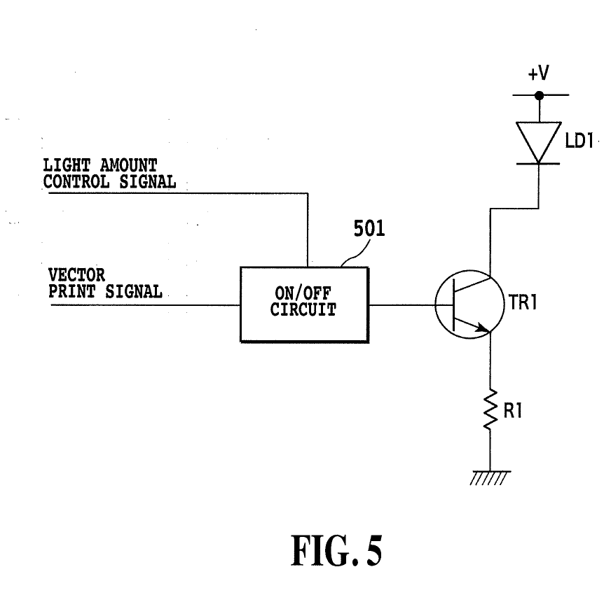

Next, the internal configuration of the scanners 407, 409, 411, and 413 will be described in detail with reference to FIG. 5. In FIG. 5, a laser device of a laser beam scanning optical system for printing a vector print signal includes a laser diode LD1. The CPU 401 inputs the light amount control signals P0 and P1 into the ON/OFF circuit 501 to control the emission power of the laser diode LD1. After the light emission amount of the laser beam is thus set, when a vector print signal output from the timing signal generator 405 is input as a pulse signal into the ON/OFF circuit 501 of the transistor TP1, a drive current flows to the LD1, a laser beam is output to perform exposure.

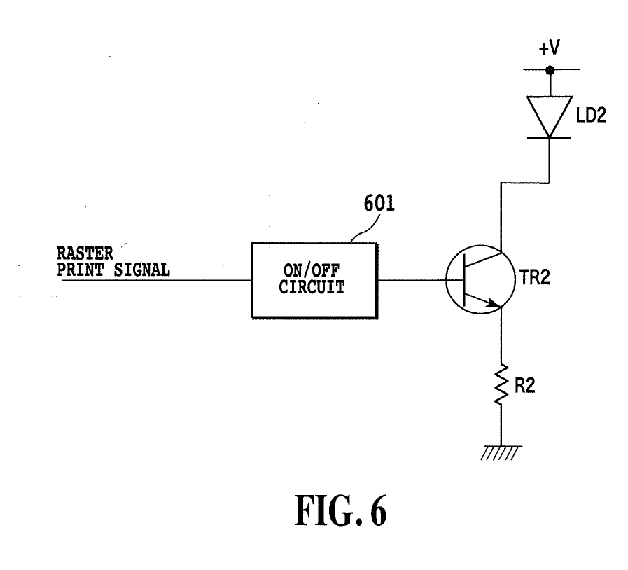

Next, the internal configuration of the scanners 408, 410, 412, and 414 will be described in detail with reference to FIG. 6. In FIG. 6, a laser device of a laser beam scanning optical system for printing a raster print signal includes a laser diode LD2. When a raster print signal is input as a pulse signal into the ON/OFF circuit 501 of the transistor TR2, a drive current flows to the LD2, and a laser beam is output to perform exposure.

As described above, according to the first embodiment, image data is separated into, for example, characters and others, and are scanned with lasers with different resolutions, respectively. Further, when developing image data of a character portion which needs a high resolution, by outputting only timing information of printing of the object, the data amount can be reduced.

At this time, for a portion having an overlap of a character and an image other than characters, light amount control signals are created based on information on image data of the character and image data of the image other than characters. Then, by controlling the light amount of the laser device of the image data based on the created light amount control signals, the latent image of the portion having the overlap of the character and the image other than characters is restrained from becoming dense, and high-quality printing is realized.

In the present embodiment, by light amount control signals generated based on a vector print signal and a raster print signal as described above, the light amount of the laser beam irradiation in the scanner for vector print signal is controlled. In the present embodiment, without limiting to this, the light amount of the laser irradiation of the scanner for raster print signal may be controlled by the light amount control signals. In this case, for example, the light amount control signal P1 is a raster print signal, and based on a vector print signal and the raster print signal, a light amount control signal P0 is generated so that the time zone in which only the raster print signal becomes “1,” becomes “1.” In the present embodiment, according to light amount control signals, the CPU 401 controls the light amount of laser beam irradiation of at least either the scanner for vector print signal and the scanner for raster print signal based on the positions (position information) of objects of the raster print signal and the vector print signal.

### Second Embodiment

Hereinafter, an image forming apparatus of the present embodiment will be described.

In the present embodiment, only components different from those of the first embodiment will be described, and the same components are attached with the same reference numerals, and description thereof will be omitted.

In the first embodiment, a polygon mirror is commonly used for scanning respective laser devices of the scanners 407 and 408, the scanners 409 and 410, the scanners 411 and 412, or the scanners 413 and 414. On the other hand, in the present embodiment, based on a scanning resolution, polygon mirrors which rotate at different speeds are provided for the scanner for vector print signal (407, 409, 411, 413) and the scanner for raster print signal (408, 410, 412, 414), respectively.

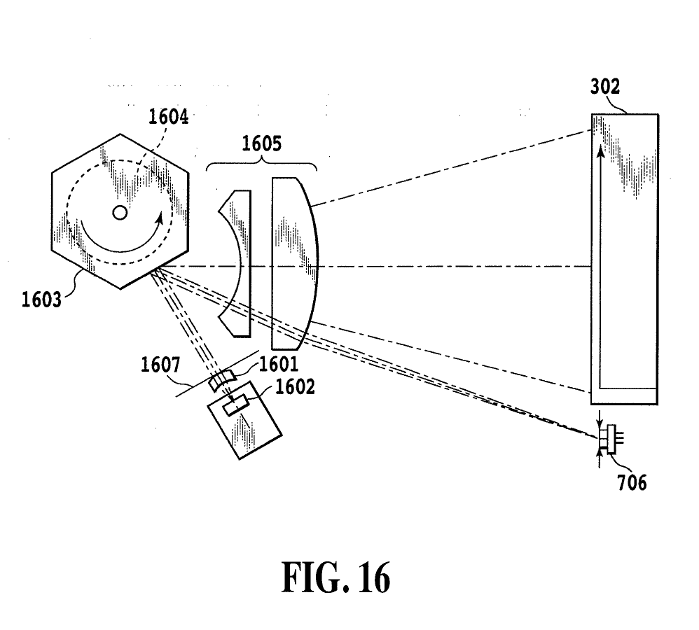

FIG. 16 is a view showing a mechanical configuration of the scanners 407, 409, 411, and 413.

In FIG. 16, a laser beam emitted from the laser device 1602 becomes substantially parallel light by the collimator lens 1601 and the diaphragm 1607, and is made incident on the rotating polygon mirror 1603 with a predetermined beam diameter.

The polygon mirror 1603 is rotated by the polygon motor 1604 at an equiangular velocity in the arrow direction shown in FIG. 16, and the reflection (advancing) direction of the laser beam made incident on the polygon mirror 1603 is deflected at the equiangular velocity along with the rotation of the polygon mirror 1603.

The rotation speed of the polygon motor 1604 is determined based on a printing resolution.

The laser beam whose advancing direction is deflected is made incident on the photosensitive material 302 via the f-θ lens 1605 and exposure-scans the photosensitive material 302.

In this case, the f-θ lens 1605 corrects a change in main scanning speed caused by a difference in optical path length to the photosensitive material 302 of the laser beam whose advancing direction is deflected by the polygon mirror 1603 so as to obtain a constant main scanning speed.

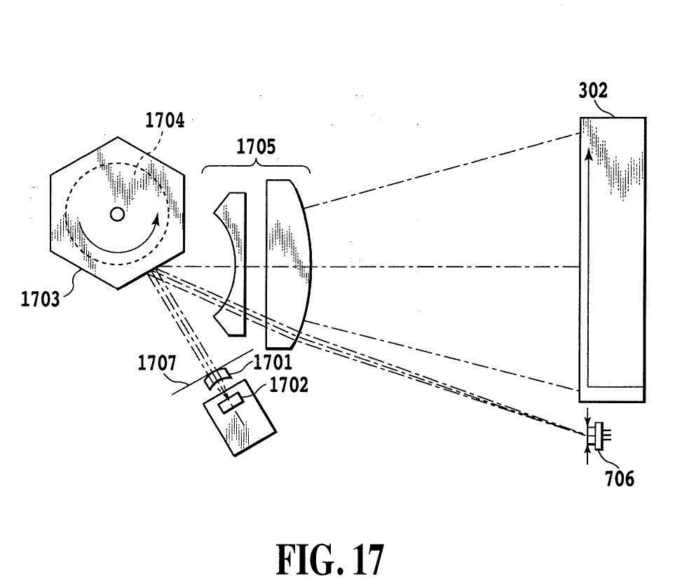

FIG. 17 is a view showing a mechanical configuration of the scanners 408, 410, 412, and 414.

The scanners 408, 410, 412, and 414 have the same configuration as that of the scanners 407, 409, 411, and 413. However, the rotation speed of the polygon motor 1704 is determined based on a printing resolution. The scanners 408, 410, 412, and 414 perform printing at a low resolution and the scanners 407, 409, 411, and 413 perform printing at a high resolution, so that the polygon motor 1604 rotates at a rotation speed higher than that of the polygon motor 1704.

With the above-described configuration, an effect unique to the present embodiment will be described.

In the first embodiment, the polygon mirror which scans the laser device for high resolution and the laser device for low resolution is shared by the laser devices, so that the following control is performed. In other words, by controlling scanning of the laser device for low resolution by rotating the polygon motor at a rotation speed adapted to scanning of the laser device for high resolution, the polygon mirror is shared. In detail, control is performed so that the scan a1 of the laser device for high resolution is performed in synchronization with the scanning of b1 by the laser device for low resolution, and during scanning of a2, a3, and a4 by the laser device for high resolution, the scanning by the laser device for low resolution is controlled not to be performed.

On the other hand, in the present embodiment, polygon mirrors which perform scanning of the laser device for high resolution and the laser device for low resolution, respectively, are prepared, and accordingly, the above-described control of the scanning of the laser device for low resolution is not necessary.

### Third Embodiment

Hereinafter, an image forming apparatus of the present embodiment will be described.

In the present embodiment, only components different from those of the first embodiment will be described, and the same components are attached with the same reference numerals, and description thereof will be omitted.

In the first embodiment, the light amount of a laser device for printing a vector print signal of a character portion, etc., is controlled, however, in the present embodiment, for example, the light amount control is also performed for a laser device for printing a raster print signal classified as an image other than characters.

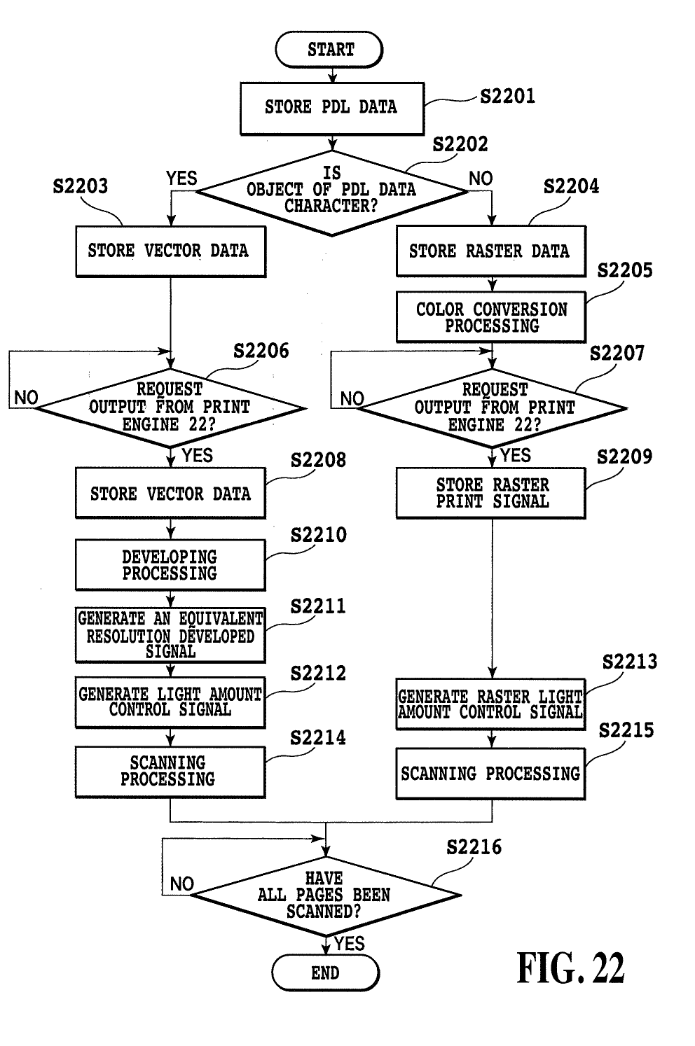

FIG. 22 is a flowchart showing processing to be performed by the image forming apparatus 2 when the image forming apparatus 2 receives PDL data from the host computer 1.

Via the host I/F 201, when the CPU 202 detects receiving of the PDL data from the host computer 1, processing according to the flowchart of the same figure is started. First, the CPU 202 temporarily stores the received PDL data in the PDL data memory region 2001 of the RAM 203 (Step S2201).

Generally, when an image to be printed is created by the host computer, by executing an application program in the computer, image data is realized by using a description language in a command format of PDL or GDI. Thereafter, by analyzing the respective commands, intermediate codes showing how to develop the commands in a band memory (in the present embodiment, RAM 203) are generated. As the intermediate codes, for each pixel, a code unique to a drawing object is generated in addition to RGB tone values. In other words, in the case of a character, “PUTCHARCACHE, (memory number),” etc., for reading out a character itself stored in the memory is generated. In the case of graphics, “RECTANGLE” or “CIRCLE” for expressing a rectangle or circle, and in the case of a bitmap image, “IMAGE” or the like is generated. Therefore, among intermediate codes input in the CPU 202, when “PUTCHARCACHE, (memory number)” is described, it is determined as being a character, and when it is not described, it is determined as not being a character. Of course, a code of vector (other than image) may be determined from an intermediate code unique to graphics other than characters.

The CPU 202 analyzes commands of PDL data and separates these into characters and others (Step S2202). In the case of a character, command information thereof is stored in the vector data memory region 2003 (Step S2203). Then, in the case of a graphic or an image, it is developed and stored in the raster data memory region 2002 (Step S2204).

In the present embodiment, raster data is developed at 600 dpi. At this time, commands of characters which overlap images and are not printed in actuality are deleted.

Next, the CPU 202 applies color conversion processing to the raster data held in the raster data memory region 2002 at Step S2204 (Step S2205). Data thus subjected to color conversion processing becomes raster print signals.

The color conversion processing is processing for converting image data expressed in three colors of RGB generated on the host computer 1 side into CMYK data capable of being processed by the print engine 22, and is performed by using tables and functions, etc., stored in the ROM 204 and RAM 303.

When the CPU 202 receives a request from the print engine 22 via the engine I/F 205 (Step S2206), it transfers vector data stored in the vector data memory region 2003 to the print engine 22.

When the CPU 202 receives requests on a color basis from the print engine 22 via the engine I/F 205 (Step S2207), it transfers raster print signals stored in the raster data memory region 2002 to the print engine 22.

Image data (vector data and raster data) transferred from the image processing apparatus 21 are input into the exposure controller 301 of the print engine 22.

The CPU 401 temporarily stores the received print data (vector data and raster data) in the RAM 403. In other words, the CPU 401 stores vector data of the received print data in the vector data memory region 4002 (Step S2208), and stores the raster print signals (raster data) in the raster print signal memory 4001 (Step S2209).

The development unit 416 creates scanning time lists 1501, 1502, 1503, and 1504 for the respective colors of CMYK based on vector data stored at Step S2208.

The scanning time list is a list of scanning timings based on the relationships between edges of each object and a main scanning line.

The CPU 401 inputs the scanning time lists 1501, 1502, 1503, and 1504 into the timing signal generator 405. The timing signal generator 405 receives values output from the time counter 404. Comparing the received value and the scanning time list 1501, 1502, 1503, or 1504, when they match each other, ON/OFF of the vector print signal is switched to create a vector print signal (Step S2210). The created vector print signal is stored in the vector print signal memory region 4003.

The CPU 401 develops the vector data at the same resolution as that of the raster data received from the image processing apparatus 21, and generates an equivalent resolution developed signal as developed data (Step S2211). The generated equivalent resolution developed signal is stored in the RAM 203.

The CPU 401 inputs the raster print signal and the vector print signal obtained as described above into the light amount control signal generator 406. The light amount control signal generator 406 creates a vector light amount control signal from the data (vector print signal and raster print signal) input according to the method described in the first embodiment (Step S2212), and stores it in the light amount control signal memory region 4004.

The CPU 401 generates a raster light amount control signal based on the equivalent resolution developed signal obtained at Step S2211 and the raster print signal (Step S2213). Details of Step S2213 will be described later.

The CPU 401 inputs the generated vector light amount control signal and raster light amount control signal into each laser driver in synchronization with the target vector print signal and raster print signal, and applies exposure processing to each photosensitive material (Step S2214, Step S2215).

At Step S2216, it is confirmed that all pages have been scanned, and then the processing by the image forming apparatus 2 is ended.

FIG. 7 is a view showing a mechanical configuration of the scanners 407 and 408.

The scanners 409 and 410, the scanners 411 and 412, and the scanners 413 and 414 have the same configuration.

In FIG. 7, laser beams emitted from the laser devices 709 and 710 are shaped into substantially parallel light by the collimator lenses 701 and 702 and the diaphragms 707 and 708, and made incident on the rotating polygon mirror 703 with a predetermined beam diameter.

The polygon mirror 703 is rotated by the polygon motor 704 at an equiangular velocity in the arrow direction shown in FIG. 7, and the reflection (advancing) direction of the laser beams made incident on the polygon mirror 703 is deflected at the equiangular velocity along with the rotation of the polygon mirror 703.

The laser beams whose advancing directions are deflected are made incident on the photosensitive material 302 via the f-θ lens 705 and exposure-scans the photosensitive material 302.

At this time, the f-θ lens 705 corrects a change in main scanning speed caused by a difference in optical path length to the photosensitive material 302 of the laser beam whose advancing direction is deflected by the polygon mirror 703 so as to obtain a constant main scanning speed.

The BD detector 706 is a beam detect sensor which detects the laser beams from the polygon mirror, and after a predetermined time since the detection of the laser beams by the BD detector 706, exposure scanning with the laser beams based on image data is started.

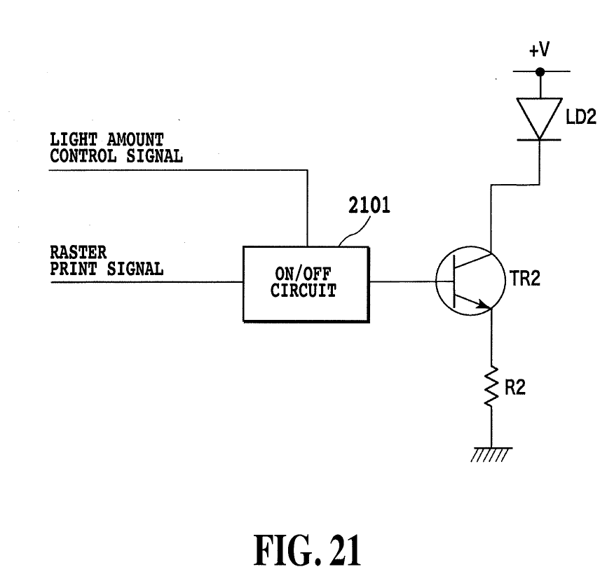

Next, the internal configuration of the scanners 408, 410, 412, and 414 will be described in detail with reference to FIG. 21. In FIG. 21, a laser device of a laser beam scanning optical system for printing a raster print signal includes a laser diode LD2. The CPU 401 inputs a raster light amount control signal into the ON/OFF circuit 2101 to control the emission power of the laser diode LD2. After the laser beam emission amount is thus set, when a raster print signal is input as a pulse signal into the ON/OFF circuit 501 of the transistor TR2, a drive current flows to the LD 2, a laser beam is output, and exposure is performed.

(Creation Processing of Raster Light Amount Control Signal)

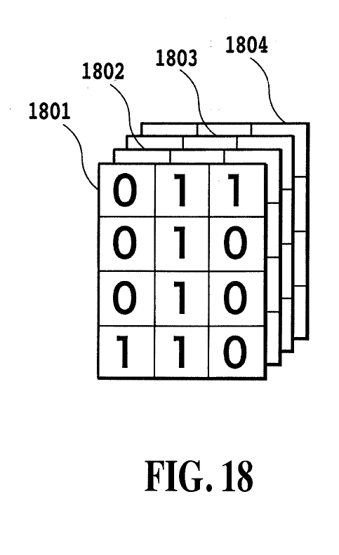

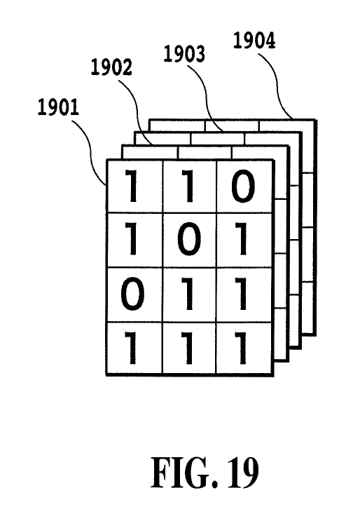

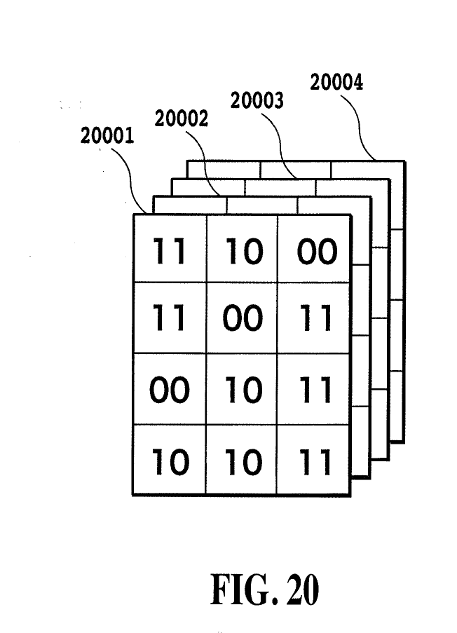

Details of Step S2213 which is processing in the exposure controller 301 will be described with reference to FIG. 18, FIG. 19, and FIG. 20.

FIG. 18 is a view schematically showing equivalent resolution developed signals of the respective colors of one page, and each of the colors of cyan 1801, magenta 1802, yellow 1803, and black 1804 is composed of a pixel number of 12 of vertical four pixels and horizontal three pixels. “0” and “1” in the pixels of cyan 1801 mean that exposure is performed for “1” and exposure is not performed for “0.”

FIG. 19 is a view schematically showing raster print signals of the respective colors of one page, and each of the colors of cyan 1901, magenta 1902, yellow 1903, and black 1904 composed of a pixel number of 12 of vertical four pixels and horizontal three pixels. “0” and “1” in the pixels of cyan 1901 mean that exposure is performed for “1” and exposure is not performed for “0.”

FIG. 20 is a view schematically showing raster light amount control signals of the respective colors of one page for controlling the light amounts of laser devices which scan the raster print signals. In FIG. 20, each of the colors of cyan 20001, magenta 20002, yellow 20003, and black 20004 is composed of a pixel number of 12 of vertical four pixels and horizontal three pixels. In FIG. 20, in the pixels of cyan 20001, “11” means that the light amount is adjusted to “strong,” “10” means that the light amount is adjusted to “weak,” and “00” means that the light amount is adjusted to “0.” The respective pixels of the signals correspond to each other, and to generate a raster light amount control signal, corresponding pixels are referred to.

The CPU 401 generates a raster light amount control signal by referring to respective pixels of the raster print signal and the equivalent resolution developed signal. In detail, a raster light amount control signal is generated as follows.

When the pixel of the raster print signal is “0,” the raster light amount control signal is set to “00.” In this case, no object is present in the corresponding pixel in the raster data, so that to adjust the light amount of laser beam irradiation for the raster print signal to “0,” the raster light amount control signal is set to “00.”

On the other hand, when the pixel of the raster print signal is “1” and the pixel of the equivalent resolution developed signal is “1,” the raster light amount control signal is set to “10.” The above-described equivalent resolution developed signal is obtained by rasterizing the vector data separated from the same page as the raster print signal at a resolution of the raster print signal. Therefore, in the equivalent resolution developed signal, a pixel of “1” means that an object is present. Therefore, in a certain pixel, when the raster print signal is “1” and the equivalent resolution developed signal is also “1,” raster data and vector data overlap in this pixel. Therefore, in a latent image after being formed, to make the density uniform between the overlapped region and other regions, the light amount of the laser beam irradiation for raster print signal must be adjusted to “weak,” and therefore, the raster light amount control signal is set to “10.”

Further, when the pixel of the raster print signal is “1” and the pixel of the equivalent resolution developed signal is “0,” the raster light amount control signal is set to “11.” In this case, in the corresponding pixel, an object is present in the raster data and no object is present in the vector data, so that to adjust the light amount of the laser light irradiation for raster print signal to “strong,” the raster light amount control signal is set to “11.”

To generate a raster light amount control signal of cyan, the CPU 401 generates cyan 20001 of the raster light amount control signal by referring to the pixels of cyan 1801 of the raster print signal and the pixels of cyan 1901 of the equivalent resolution developed signal. The same operation is performed for generating raster light amount control signals of other colors.

As described above, for example, image data of, for example, a character portion, which is classified as vector data is drawn in advance, and compared with, for example, image data classified as other than character portions. Then, by controlling the light amount of exposure for the portion having an overlap of images, the latent image of the portion having an overlap of images of a character and an image is restrained from becoming dense, and accordingly, high-quality printing is realized. By developing the image data of a character portion which is printed at a high resolution, at a resolution of image data other than character portions without developing at the high resolution, and comparing the image data, high-speed printing is realized without greatly increasing the data amount and without putting a burden on the image processing system.

### Fourth Embodiment

In the above-described embodiments, a method for acquiring print data by the image processing apparatus 21 is described in which the image processing apparatus 21 receives print data from the host computer 1 via a network, etc., however, the method is not limited to this. In the present embodiment, any method for acquiring print data by the image processing apparatus 21 may be used. For example, an image reader such as a scanner which obtains image data by reading an image is connected to the image processing apparatus 21, and print data is obtained based on the image data read by the image reader. Alternatively, a device such as a magnetic disk drive, an optical disk drive, or a memory card reader for reading data from various recording media is connected to the image processing apparatus 21, and print data is obtained from the recording medium.

In the above-described embodiments, it is not essential that the image forming apparatus 2 includes the image processing apparatus 21. Therefore, the image processing apparatus 21 and the image forming apparatus 2 may be provided separately in such a manner that the image processing apparatus 21 is provided in an external device such as the host computer 1.

### Other Embodiments

The purpose of the present invention can also be realized by executing the following process. That is, a process in which a recording medium, in which a program code of a software that realizes the functions of the above-described embodiments is recorded, is supplied to the system or apparatus, and then a computer of the system or apparatus (such as CPU or MPU) reads out the program code stored in the recording medium. In such a case, the program code readout from the recording medium itself realizes the functions of the above-described embodiments, and the recording medium where the program code is stored as well as the program code are included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-183900, filed Jul. 15, 2008, which is hereby incorporated by reference herein in its entirety.

What is claimed is:

1. An image forming apparatus, comprising:
a component configured to obtain vector data and raster data obtained by dividing the print data according to attributes of objects;
a printing timing generating component configured to obtain an irradiation timing of a light emitting device when printing each object based on edges of the object of the obtained vector data, and generate a vector print signal for printing the vector data from the timing;
a first scanning component configured to scan a vector print signal generated in the printing timing generating component by a light emitting device; and
a second scanning component configured to scan the obtained raster data by the light emitting device according to a resolution of the raster data.

2. The image forming apparatus according to claim 1, further comprising: a component configured to control a light amount of a laser beam irradiated by at least either one of the light emitting device of the first scanning component and the second scanning component based on position information of the raster data and the vector data.

3. The image forming apparatus according to claim 1, wherein
the printing timing generating component comprises:
a component configured to detect the edges by calculating coordinates of a start position and an end position of drawing of an object present on each main scanning line of the vector data; and
a component configured to calculate the timing so that the first scanning component irradiates the object portion based on the detected edges.

4. The image forming apparatus according to claim 1, wherein the first and second scanning components have polygon mirrors which rotate at different numbers of rotations based on resolutions of scanning of the first and second scanning components, respectively.

5. The image forming apparatus according to claim 1, wherein the first and second scanning components share a polygon mirror.

6. The image forming apparatus according to claim 5, wherein the shared polygon mirror rotates at a number of rotations based on a resolution of scanning of the first scanning component, and
the image forming apparatus further comprises a component configured to perform irradiation control for each scanning line in the second scanning component.

7. The image forming apparatus according to claim 1, further comprising:
a component configured to develop the vector data in advance at the same resolution as that of the raster data and output the developed data; and
a component configured to control a light amount of a laser beam of the second scanning component based on the raster data and the developed data.

8. The image forming apparatus according to claim 1, wherein the raster data and the vector data are image data in the same page.

9. An image forming method, wherein
the method comprising the steps of:
obtaining vector data and raster data obtained by dividing print data according to attributes of objects;
obtaining an irradiation timing of a light emitting device when printing each object based on edges of the object of the obtained vector data, and generating a vector print signal for printing the vector data from the timing;
scanning the vector print signal generated at the step of generating the vector print signal by the light emitting device; and
scanning the obtained raster data by the light emitting device according to a resolution of the raster data.

10. An image forming method, wherein
the method comprising the steps of:
dividing obtained print data into vector data and raster data according to attributes of objects; and
transmitting the divided raster data and vector data to an image forming apparatus.

11. A program on a computer readable medium for performing an image forming method, wherein the method comprising the steps of:
obtaining vector data and raster data obtained by dividing print data according to attributes of objects;
obtaining an irradiation timing of a light emitting device when printing each object based on edges of the object of the obtained vector data, and generating a vector print signal for printing the vector data from the timing;
scanning the vector print signal generated at the step of generating the vector print signal by the light emitting device; and
scanning the obtained raster data by the light emitting device according to a resolution of the raster data.
